(19) United States
(12) Patent Application Publication
(10) Pub. No.: US 2017/0368653 A1
(43) Pub. Date: Dec. 28, 2017

(54) Working Device

(71) Applicant: FESTO AG & Co. KG, Esslingen (DE)

(72) Inventors: Frank Baumann, Hochdorf (DE); Thomas Feyrer, Esslingen (DE)

(21) Appl. No.: 15/627,648

(22) Filed: Jun. 20, 2017

(30) Foreign Application Priority Data
Jun. 22, 2016 (DE) 102016211093.4

(51) Int. Cl. B23Q 5/38; B23Q 1/62; B23Q 3/18; F16H 19/04

(52) U.S. Cl. CPC B23Q 5/385; F16H 19/04; B23Q 1/621; B23Q 3/18

(57) ABSTRACT

A working device is proposed, with a positioning system, containing at least one pallet that is positionable and movable by performing a two-dimensional positioning movement in a positioning plane. The pallet is provided with at least one application area, on which in a work zone by means of a handling unit an application can be performed. The work zone is isolated from the handling unit by a protective cover, which is penetrated by an access opening, through which the handling unit can be moved by an application movement directed perpendicularly to the positioning plane, in order to perform an application in the application area of the pallet positioned in the area of the access opening.

### BACKGROUND OF THE INVENTION

The invention relates to a working device, with a positioning system, containing at least one pallet that is positionable and movable by performing a two-dimensional positioning movement in a positioning plane, having at least one application area, on which in a work zone of the positioning plane by means of a handling unit of a handling device an application can be performed.

EP 2 982 472 A1 discloses a working device, equipped with a positioning system of the abovementioned kind, having a plurality of pallets, which by means of a system of gears can be moved two-dimensionally in a positioning plane and positioned as required. With the positioning system it is, by way of example, possible to position the pallets so that the application areas intended for them are positionable in an area of the positioning plane that can be designated as a work zone, in order there by means of a handling unit of a handling device to perform a particular application, by way of example a fluid filling process, a mounting process or an assembly process. This essentially poses a contamination problem, since particularly with handling measures in the medical or microbiological fields, but also in other applications, contamination of the pallet and the application areas provided thereon should be avoided.

DE 102 56 250 A1 describes a system and a method for mounting electronic components on flexible substrates. The substrates are placed on movable pallets, with the help of which they can be moved relative to a gas nozzle, which emits a gas jet with the help of which solder paste can be melted which is used to secure electronic components. Between the gas nozzle and the substrate there is a stencil with openings, which expose certain areas of the substrate. Each pallet is combined with a stencil to form a unit which can be moved uniformly relative to the gas nozzle. In another configuration, the pallet and the stencil are not moved, while the gas nozzle crosses the stencil for selective heating of the substrate areas concerned.

### SUMMARY OF THE INVENTION

The underlying object of the invention is to provide a working device that meets strict hygiene requirements.

To achieve this object, in combination with the abovementioned features, it is provided that the work zone is separated from the handling unit by a protective cover, having an access opening for the handling unit that can be moved perpendicularly to the positioning plane by performing an application movement, wherein by the positioning movement each application area of the pallet can be positioned in the area of the access opening, in order to then allow an application by means of the handling unit through the access opening.

The protective cover can effectively prevent contamination of the work zone and the pallets located therein, including the pallet load. Contamination caused by the movement of the handling unit is prevented by the protective cover at an entrance to the work zone. The protective cover can be thoroughly cleaned from the outside, without contaminating the content of the work zone. The access opening nevertheless allows problem-free performance of an application on selected application areas of the pallet, in that the pallet with the application area concerned is positioned opposite the access opening and as a result is accessible without problems to the handling unit that reaches through the access opening. Thus, despite the protective cover in the application areas of a pallet positioned in the area of the access opening, filling applications, mounting applications or assembly applications can be performed. The two-dimensional movability of the pallets allows on the part of the handling device a design for an application movement running purely perpendicularly to the positioning plane, so that the kinematic requirements on the handling device and accordingly the associated provision costs can be kept relatively low. Nevertheless, there is obviously the possibility of designing the handling device such that it allows a multi-dimensional movability of the handling unit in order, by way of example, to pick components to be mounted from a provision area positioned aside the access opening and bring these to the area of the access opening for the performance there of the application movement.

Advantageous developments of the invention are indicated by the subclaims.

The positioning plane can in principle have any alignment. A horizontal alignment is considered to be particularly advantageous, where the upper side of the work zone is covered by the protective cover and the handling unit is positioned above the work zone, wherein the application movement that can be performed by the handling unit when reaching through the access opening is a vertical movement.

It is considered particularly advantageous if the reach of the protective cover is such that it extends across the entire positioning plane. In this way, the pallets are also protected from contamination if they are located outside the work zone. This allows strict hygiene requirements to be met.

In a simple and economical embodiment of the working device, just a single work zone is present for performing the applications. High variability and particularly the performance of a plurality of coordinated applications is, however, favoured in that the working device has a plurality of work zones, across which the positioning plane stretches and in which the pallets can be moved alternately and/or one after the other by the corresponding performance of the positioning movement. Expediently, each of these work zones is associated with a handling unit physically separated by the protective cover, access by which to the pallets located behind the protective cover is ensured in that the protective cover in the area of each work zone has an access opening for the handling unit concerned.

A plurality of work zones defined by the positioning plane can be arranged directly next to each other. However, the invention also allows positioning of the work zones spaced apart from each other, so that the applications taking place there most certainly do not interfere with each other. There is, particularly, also the possibility of assigning a plurality of work zones different types of applications in order, by way of example, to perform in a work zone a filling of the application areas of a pallet, which then in another work zone by means of a handling unit located there are at least to some extent emptied again. There is also the possibility of moving the pallets one after another in different work zones, in order in their application areas to perform work zone-specific and coordinated applications, by way of example the successive mounting of components with various parts.

Work zones spaced apart from each other are expediently interlinked by a transfer zone that is similarly covered by the positioning plane, through which the pallets pass as they move between the various work zones. Since in these transfer zones no specific positioning of the pallets is necessary, expediently there the positioning system is designed so that it can produce an exclusively one-dimensional, linear positioning movement. The requirements of the drive technology for moving the pallets in the transfer zone are therefore relatively modest and can be economically implemented.

A configuration of the positioning system as an x-y-positioning system is considered to be particularly advantageous, in which the pallets present in order to perform the positioning movement can be driven relative to a stationary system base both alternately and also overlaid on an x-drive movement and on a y-drive movement. The x-drive movement is a driven movement in the x-axial direction, while the y-drive movement is a driven movement in a y-axial direction at right angles to the x-axial direction. Such an x-y-positioning system can, by way of example, be a gantry system or a cross-slide system. However, implementation as a drive gear system is considered to be particularly practical, particularly such as described in EP 2 982 472 A1, the disclosure content of which in relation to the design of the positioning system is incorporated into the subject matter of this description. In such a gear system each pallet is equipped on its underside facing towards the system base with a driven gear structure, comprising a number of intermittently distributed driven teeth and which can be brought into engagement with driving gears arranged rotatably on the system base, containing both x-driving gears and y-driving gears, wherein the x-driving gears can produce a positioning movement in the x-axial direction and the y-driving gears a positioning movement in the y-axial direction. As they pass through the positioning plane the individual pallets engage one after another with various of the plurality of driving gears, and are thus basically passed between individual driving gears.

At least one and expediently each pallet is particularly built so that it has a pallet main body and—in this regard separate—one or more pallet application body or bodies, wherein each pallet application body defines an application area for the handling unit. The pallet application bodies are, by way of example, sample receptacles used in medical engineering, wherein the handling unit is used to fill these receptacles with biological samples and/or to remove medical samples from these receptacles.

The pallet preferably has a plurality of application areas arranged parallel to the positioning plane with a matrix-like distribution. By way of example, the pallet has application areas arranged in an x-y-grid made up of receptacles or parts to be handled.

The pallets preferably have a tray-like pallet main body, the open side of which faces towards the protective cover. In this way, contamination which during processing of a pallet positioned below an access opening reaches the work zone through the access opening, is intercepted by the pallet main body and cannot cause any further soiling of the parts of the positioning system located below the protective cover. Fluids dripping through the access opening, particularly, are intercepted and cannot contaminate the drive system responsible for generating the positioning movement, particularly a driving gear system.

The protective cover preferably has a plate-like configuration, allowing simple manufacture and assembly. It is preferably arranged to be detachable and removable on a system base of the positioning system, so that it can be conveniently removed for maintenance work or cleaning purposes. The protective cover preferably has a smooth configuration, allowing simple and thorough cleaning.

Expediently, the protective cover consists of a see-through material. This allows the process taking place in the work zone to be visible at all times from outside and this can also if necessary be monitored from the outside by means of a camera. Barcodes or other means of identification applied to a pallet or to the application areas, can be conveniently read from the outside with a see-through protective cover. The protective cover can essentially comprise any desired material, wherein, however, due to its neutrality and ease of cleaning glass is preferred. The protective cover can also be coated, in order to filter out undesired external radiation, such as UV radiation, which is advantageous if the pallets are filled with photosensitive media.

Expediently, the protective cover screens or isolates a positioning space of the positioning system, containing the work zone, from the surrounding environment. This offers the advantageous possibility of climate control of the positioning space, including the work zone, if required and depending on the applications to be performed or the equipment, cooling or heating of the pallet. This also allows the pallets, including their load, to be kept in a germ-free environment throughout the process. Also advantageous are measures to apply excess pressure to the positioning space containing the work zone, to prevent undesired penetration of contamination from the surroundings.

A particularly advantageous measure is considered to be to associate the access opening with a barrier device to impede or prevent the ingress of contamination from the handling unit side into the work zone. Such a barrier device comprises, by way of example, a collar-like elevation in the protective cover around the access opening, which in the area surrounding the access opening prevents liquids dropping onto the outside of the protective cover from entering the access opening. Particularly advantageous are barrier measures through which the access opening is covered while no access is required by the handling unit. This can particularly involve at least one rubber-elastic diaphragm spanning the access opening, which can be expanded by the handling unit when it is moved through the access opening. A further advantageous possibility for a barrier device is particularly an elastically deformable bellows, secured on one side to the protective cover and on the other to a supporting section of the handling device supporting the handling unit, so that the access opening, irrespective of the current position of the handling unit, and particularly continuously, is isolated from the environment.

In an advantageous configuration of the working device, the protective cover does not just serve to screen the work zone, but also to support the pallets in a direction at right-angles to the positioning plane. This allows it to be ensured that the power train generated by a drive system acting on the pallets is not interrupted. Particularly if the drive system is a driving gear system, in which the pallets are equipped with a driven gear structure provided on them, a protective cover configured as a support device can prevent the pallet lifting from driving gears arranged on a system base. This increases operational reliability.

Preferred application areas for the working device are applications for filling, sorting, inspecting, storing, buffering and transporting and also the application of adhesive and/or sealant to associated carrier components.

### BRIEF DESCRIPTION OF THE DRAWINGS

The invention is described in more detail below using the attached drawing. This shows as follows:

FIG. 1 a perspective view of a preferred embodiment of the working device according to the invention, wherein pallets located under a protective cover are shown schematically by just a dotted outline;

FIG. 2 the working device from FIG. 1 in a top view seen in the direction of arrow II, wherein the protective cover is shown only in part allowing the components below to be seen;

FIG. 3 a perspective view of a section of the working device in the area of sectional plane III-III from FIG. 2, wherein a partial sub-view of a pallet is shown separately, indicating a preferred driven gear structure of the pallet;

FIG. 4 a flat sectional view of the section of the working device illustrated in FIG. 3;

FIG. 5 a sectional and highly schematic view of a section of the working device in the area of an access opening of the protective cover, equipped with a preferred configuration of a barrier device;

FIG. 6 a further embodiment of a barrier device corresponding to the method of presentation in FIG. 5; and

FIG. 7 an embodiment, also corresponding to the method of presentation of FIG. 5, of a barrier device preventing the penetration of contamination into the access opening.

### DETAILED DESCRIPTION

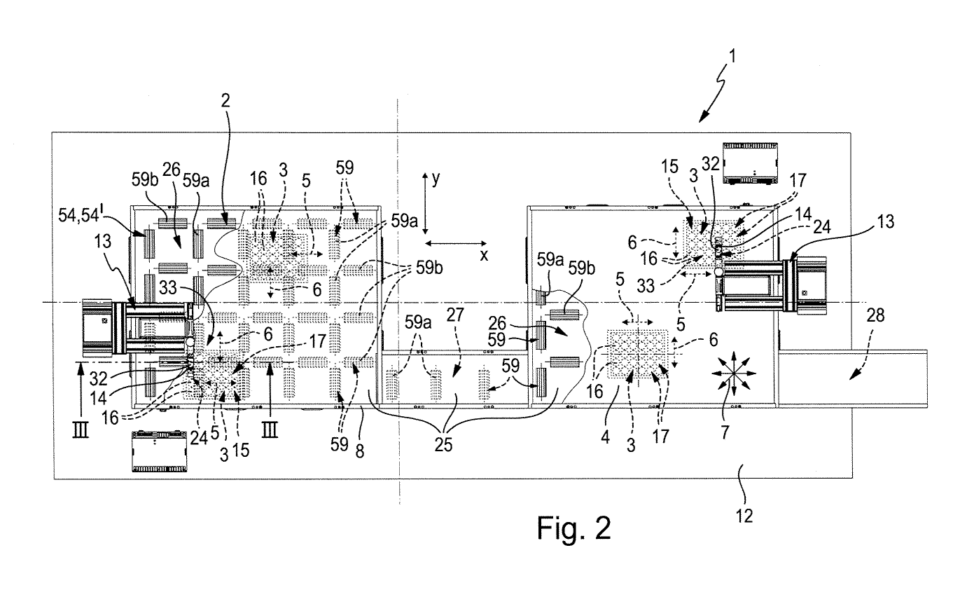

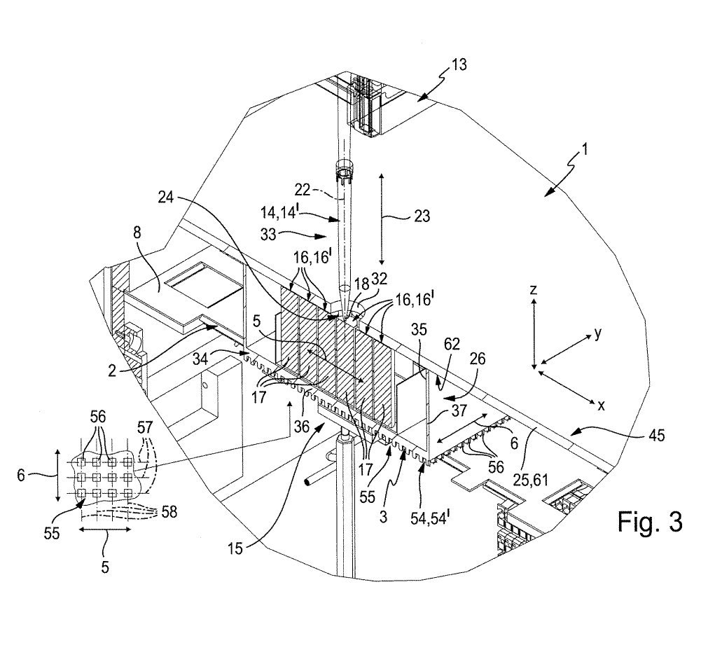

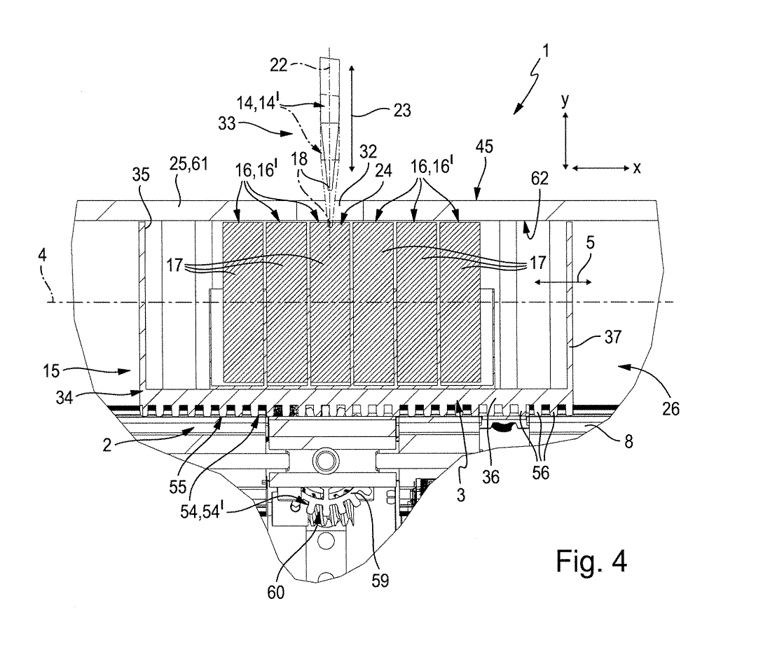

The drawing illustrates a working device designated as a whole by reference numeral 1, equipped with a positioning system 2, comprising at least one pallet 3, movable in a positioning plane 4 running parallel in to the drawing plane in FIG. 2 and positionable as required. The positioning system 2 preferably comprises a plurality of such pallets 3, which particularly can be moved and positioned independently of one another, which holds true for the exemplary embodiment.

Each pallet 3 can be moved two-dimensionally at least in certain areas of the positioning plane 4. If it is imagined that the positioning plane 4, according to the arrows contained in the figures, stretches between an x-axis and a y-axis at right-angles thereto, the positioning system 2 can be referred to as an x-y-positioning system, allowing a positioning movement of the individual pallets 3 both in the x-axial direction and in the y-axial direction. The positioning system 2 is preferably configured here such that the positioning movement is not restricted to these two axial directions at right-angles to one another, but can also be a movement which is made up of simultaneous and overlaid part-movements directed in the x-axial direction and in the y-axial direction, which in the following to allow a clearer distinction are referred to as the x-driven movement 5 and as the y-driven movement 6. The positioning movement that can be achieved by this is shown in the drawing as 7 by multiple arrows.

The positioning movement 7 of the pallets 3 takes place relative to a system base 8 of the positioning system 2, which particularly comprises a rigid body structure and, by way of example, is designed as a frame. The system base 8 serves for stationary fixing of the positioning system 2, by way of example for positioning on, and if necessary securing to, a foundation 12.

In an advantageous embodiment of the working device corresponding with the exemplary embodiment, the positioning plane 4 is aligned horizontally. Here, the foundation 12 is particularly positioned on the floor of a building accommodating the working device 1.

The working device 1 includes at least one and if necessary also a plurality of handling devices 13, wherein the exemplary working device 1 is equipped with two such handling devices 13. The handling devices 13 are, by way of example, installed at the edge of the positioning system 2.

Each handling device 13 is equipped with at least one handling unit 14, configured for the task to be performed with it. With this handling unit 14, in a work zone 15 included in a certain area of the positioning plane 4, the working device 1 can perform a specific application on a pallet 3 currently positioned in this work zone 15. This application relates to a certain, locally delimited area of the pallet 3, referred to as an application area 16. Each pallet 3 has at least one such application area 16 and particularly, where the exemplary embodiment is concerned, a plurality of such application areas 16, arranged next to each other in a plane parallel to the positioning plane. These application areas 16 are preferably arranged parallel to the positioning plane 4 with a matrix-like distribution, particularly in an x-y-matrix, so that a plurality of rows of application areas 16 per pallet 3 result arranged next to one another with parallel alignment.

In the exemplary embodiment illustrated, each application area 16 is formed of a fill opening of a receptacle-like application body 17. Accordingly, the pallets 3 of the exemplary embodiment are each equipped with a plurality of such receptacles or receptacle-like application bodies 17. The application areas 16 of these configured as fill openings 16′ point upwards and thus allow the filling or removal of liquid and/or solid substances. The receptacle-like application bodies 17 are, by way of example, test tubes.

In connection with a receptacle-like configuration of the application body 17, the handling unit 14 is designed as a filling unit 14′, having particularly a tubular or lance-shaped longitudinal form and at a free end having a delivery and/or intake opening 18. With the help of the handling unit 14, the receptacle-like application bodies 17 can be filled and/or emptied, in that the handling unit 14 with its delivery and/or intake opening 18 is beforehand placed in the application area 16 of the application body 17, as an example, therefore, in the area of a fill opening 16′. During such a filling and/or emptying process, during which the handling unit 14 in the area of its delivery and/or intake opening delivers or takes in a liquid substance, the handling unit 14 is preferably arranged with longitudinal axis 22 perpendicular to the positioning plane 4, wherein the delivery and/or intake opening 18 points downwards.

With a suitable configuration of the application areas 16 and the handling unit 14, the working device 1 is also suited to performing other applications, by way of example performing gluing applications or assembly applications. In assembly applications, the application bodies 17 are by way of example represented by workpieces, having as the application area 16 a thread, in which by means of a handling unit 14 configured as a screwing unit a screw can be screwed.

At least when performing the respective application, the handling unit 14 is positioned in a direction perpendicular to the positioning plane 14 opposite the work zone 15. In the exemplary embodiment, the handling unit 14 is positioned vertically above the work zone 15 here. The handling device 13 is configured so that it can drive the handling unit 14 for a movement referred to as an application movement 23, which preferably involves a purely linear movement and the movement direction of which runs perpendicularly to the positioning plane 4. In relation to the exemplary embodiment, this means that the handling unit 14 during the application movement 23 can be moved in the sense of approaching the work zone 15 and in the sense of moving away from the work zone 15, which in real terms manifests itself as moving up or down.

Where the object of application calls for this, the handling unit 14 in connection with the application movement 23 can also be rotated about its longitudinal axis 22, which particularly is relevant when performing screwing processes.

In the exemplary embodiment, the handling device 13 is configured such that its handling unit 14 can exclusively perform an application movement 23 perpendicular to the positioning plane 4, in the exemplary embodiment therefore vertically, in two opposing directions. The structural and control-related design of the handling device 13 is therefore particularly economical. The filling unit 14′ is, by way of example, connected to a reservoir, from which substance to be applied to it in the pallet 3 can be supplied.

In an exemplary embodiment (not shown) the handling device 13 is configured for generating a multiaxial movement of the handling unit 14 and comprises, by way of example, a manipulator, which can drive the handling unit 14, apart from the application movement 23, to a transfer movement, during which the handling unit 14 can transfer the parts to be applied in the work zone 15 or the parts to be picked in the work zone 15 from or to a delivery or discharge zone spaced apart from the work zone 15. Such a transfer movement can, by way of example, take place in a transfer plane parallel to the positioning plane 4, wherein a linear movement and/or a rotational movement may be involved.

The handling unit 14 carries out the applications relating to the different application areas 16 always at the same point of the work zone 15, which in the following for a clearer distinction is referred to as a manipulation area 24. In order to perform the applications concerned, the pallets 3 are moved by the positioning movement 7 so that their application areas 16 are positioned in a selected order one after the other in the manipulation area 24. Consequently, on the part of the handling unit 14 it is neither necessary nor envisaged to perform a movement in a plane parallel to the positioning plane 4, in order to move the individual application areas 16 of the pallets 3.

An important aspect of the working device 1 is considered to be that the work zone 15 is separated from the handling unit 14 by a protective cover 25. The protective cover 25 stretches expediently in a plane parallel to the positioning plane 4 and is expediently configured so that it covers not just each work zone 15, but the entire positioning plane 4 with all pallets 3 located there, irrespective of the current pallet position.

The protective cover 25, together with the system base 8, delimits an internal space of the positioning system 2 referred to as a positioning space 26, extending in parallel with the positioning plane 4 and in which all pallets 3 are accommodated for performing their positioning movement 7. The work zones 15 are formed by sections of the positioning space 26. Whereas in an exemplary embodiment (not shown), the work zones 15 inside the positioning space 26 are immediately adjacent to one another, in the exemplary embodiment they are arranged in the positioning plane 4 at a distance from each other and connected to each other by a transfer zone 27, formed by a section of the positioning space 26, spatially connecting two work zones 15 adjacent to each other.

The pallets 3 can be moved by means of the positioning movement 7 through each transfer zone 27 between the work zones 15 connected together by the transfer zone 27. The positioning system 2 is preferably configured so that the positioning movement 7 that can be performed in the transfer zone 27 is exclusively a linear, one-dimensional movement, offering the advantage that the positioning system 2 can be implemented in the transfer zone 27 very economically. Thus, the positioning system 2 of the exemplary embodiment is configured in a transfer zone 27 such that the positioning movement 7 there comprises exclusively an x-driven movement 5, wherein this x-driven movement 5 can nevertheless be actively generated within the transfer zone 27 by the positioning system.

The positioning plane 4 can also consist of at least one feeding and/or output zone 28, implemented in a section of the positioning space 26, attached to a work zone 15. Through this feeding and/or output zone 28 pallets 3 can be introduced into or removed from the positioning system 2.

The protective cover 25 can have a one-piece or integral design across the entire positioning space 26. Preferably, however, it comprises a plurality of independent protective cover subsections 25a, associated with the various work zones 15, transfer zones 27 and feeding and/or output zones 28 and which are preferably secured individually to the system base 8. These multiple parts make handling easier during assembly or removal of the system base 8 in connection with maintenance and/or cleaning work. It is advantageous overall if the protective cover 25, which relates to the exemplary embodiment, is fixed to the system base 8 so that it can be detached and removed. The protective cover 25 preferably rests from above on the system base 8 and in so doing covers the positioning space 26 located below.

The protective cover 25 has, in the area of each of the manipulation areas 24 described above, an access opening 32. The access opening 32 creates a connection between a work zone 15 of the positioning space 26 and the zone positioned on the opposite side of the protective cover 25, known as the handling zone 33, in which the handling unit 14 is located. The handling unit 14 when performing its application movement 23 can at least partially pass through the access opening 32, to allow it to interact as intended with the application area 16 of the pallet 3 that has been positioned during the positioning movement 7 in the associated manipulation area 24 of the work zone 15.

Consequently, by means of the handling unit 14 through the access opening 32 applications can be performed on the application area 16 of a pallet 3 currently positioned in the adjacent manipulation area 24, wherein the protective cover 25 at the same time protects the application area 16 from undesired contamination.

In the area of each work zone 15, the protective cover 25 has an access opening 32 of the kind described above. The protective cover 25 preferably has in the area of each work zone 15 precisely one access opening 32, although it is quite possible to allocate one or more work zones 15 of a plurality of access openings 32 spaced apart from each other 32 in the protective cover 25, in order, by way of example, to allow access by a handling unit 14 with a complex structure or in order, by means of a plurality of handling units 14, to perform simultaneous applications on different application areas 16 of one and the same pallet 3.

The preferred plate-shaped protective cover 25 preferably has, at least in the area of each work zone 15, but expediently in its entirety, a see-through configuration. In this way, the applications taking place in the work zone 15 can be conveniently monitored from the outside, either by human eye or by means of a camera. A see-through protective cover 25 can also be used, by means of reading devices located outside the positioning space 26, to read identifications provided on the pallets 3, used to monitor the positioning movement 7 and/or to control and/or monitor the type of individual applications to be performed by the handling unit 14.

The protective cover 25 preferably consists of glass, with plate glass being particularly preferred here. Essentially, though, any material can be chosen for the protective cover which could also be in a metal or plastic material.

At least one and preferably each pallet 3 preferably has a multipart configuration and then consists of a pallet main body 34 and at least one in this case separate application body 17 defining an application area 16, as already referred to above. Each pallet 3 is expediently equipped with a plurality of application bodies 17.

Essentially, application body 17 and pallet main body 34 can be implemented as a firmly connected unit, quite possibly with a one-piece construction. It is more practical, however, for the configuration of the application body 17 and the pallet main body 34 to be independent of one another, as also implemented in the exemplary embodiment, offering the possibility to remove the application body 17 as necessary from the pallet main body 34 and/or as necessary to load one and the same pallet main body 34 with different types of application bodies 17. It has proven particularly advantageous for the pallet main body 34 to be in the form of a tray and to place it in the positioning space 26 so that a tray opening 35 is facing towards the protective cover 25. The wall of the tray-like pallet main body 34, by way of example comprising a bottom wall 36 on the opposite side from the protective cover 25 and a side wall 37 protruding from the edge of the bottom wall 36 in the direction of the protective cover 25, and extending all around the bottom wall 36, is impervious to fluid, so that the pallet main body 34 defines a collection tray, which intercepts liquid or also solid contamination, which during an application performed on the pallet 3 enters through the access opening 32 from the outside into the positioning space 26.

With filling applications particularly, there is a risk that before or after the filling process or due to slopping of fluid certain fluid content will splash and enter the work zone 15 through the access opening 32. The tray-like pallet main body 34 positioned there intercepts this fluid content, however, so that it cannot contaminate the area of the positioning space 26 located outside of the pallet.

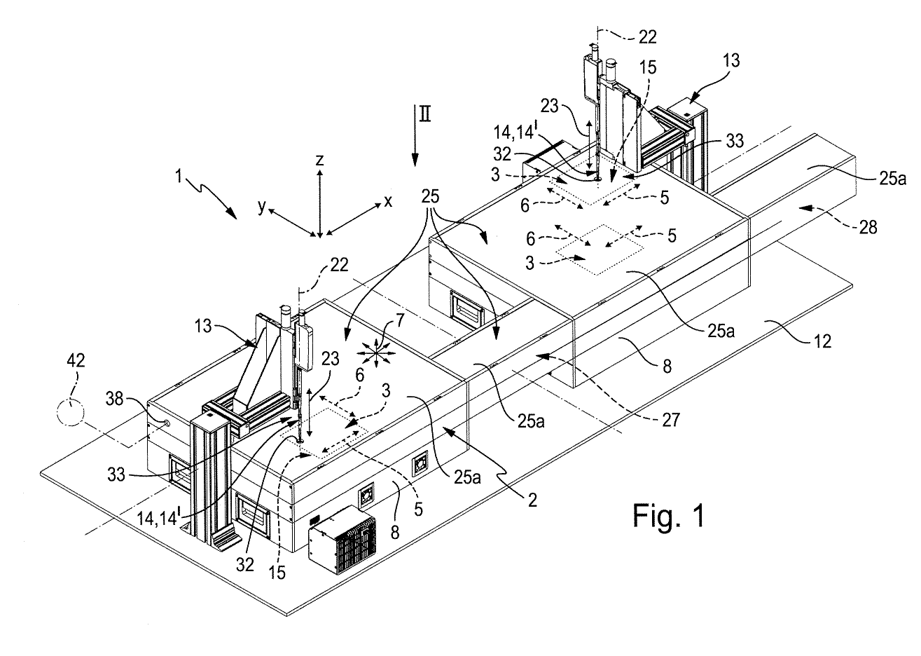

In a preferred configuration of the working device, the positioning space 26, apart from the at least intermittently open access openings 32, is sealed off from the environment. The pallets 3 are thus introduced encapsulated into the positioning space 26. This offers the advantageous possibility of, by way of example, climate control of the positioning space 26 and/or applying excess pressure to it to prevent penetration of polluted ambient air. In FIG. 1 in this connection on the system base 8 of the positioning system 2 a conditioning opening 38 is provided, to which a conditioning device 42, shown merely schematically, can be connected, by way of example an air conditioner or a pressurisation device.

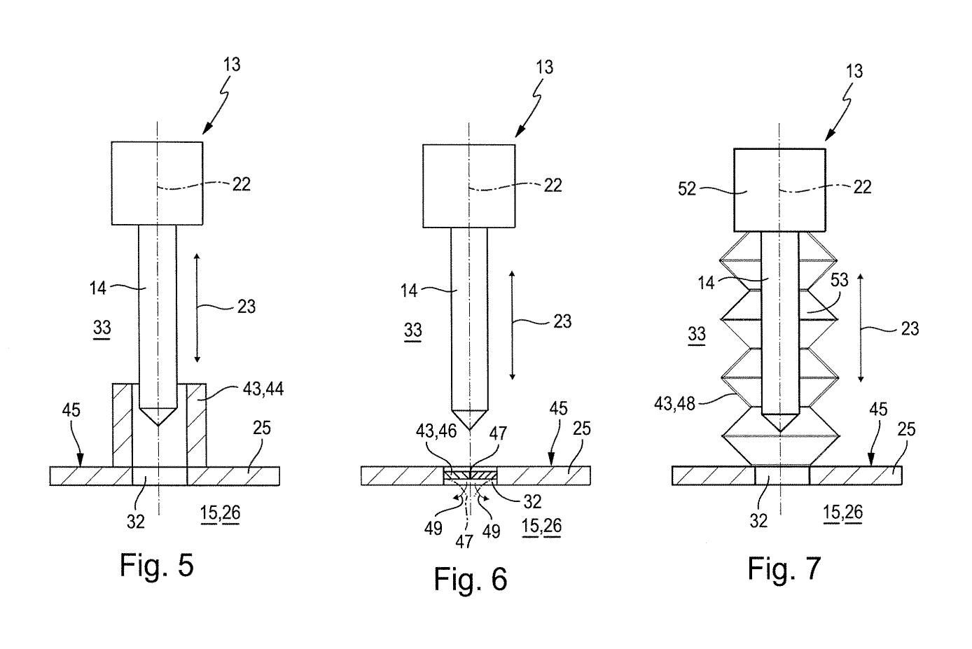

It is advantageous if at least one and preferably each access opening 32 is associated with a barrier device 43, which at least intermittently impedes or completely prevents entry of contamination from the handling zone 33 into the work zone 15. FIGS. 5 to 7 show three different exemplary embodiments of such a barrier device 43.

The barrier device 43 of FIG. 5 forms an obstacle to the entry of contamination, without fully closing the access opening 32. The barrier device 43 of FIG. 6 ensures that the access opening 32 is only open during access by a handling unit 14 and for the rest of the time is closed. In the exemplary embodiment of FIG. 7, the barrier device 43 ensures continuous isolation of the access opening 32 of the handling zone 33, irrespective of the current operating position of the handling unit 14.

The barrier device 43 of FIG. 5 comprises a circularly structured, collar-like elevation 44, surrounding the access opening 32 and from which the outside of the protective cover 25 facing away from the positioning space 26 protrudes in the axial direction of the application movement 23. Generally, the collar-like elevation 44 is preferably in the form of a sleeve. The handling unit 14 can plunge into the work zone 15 through the collar-like elevation 44 and the subsequent access opening 32.

The collar-like elevation 44 expediently has a one-piece design with the protective cover 25 but, in this regard, can also be a separate fixed barrier body.

Through the barrier device 43, liquid contamination, settling on the outer surface 45 of the protective cover 25 opposite the positioning space 26, is contained and entry through the access opening 32 prevented. Thus, cleaning work using fluids can be performed on the outer surface 45 of protective cover 25, without the danger of the cleaning fluid penetrating into the positioning space 26.

In the exemplary embodiment of FIG. 6 the barrier device 43 comprises at least one rubber-elastic diaphragm 46 spanning the access opening 32. The diaphragm 46 is slotted to form at least one access slit 47, wherein the sides of the slit are butted tightly together to form a seal, unless the handling unit 14 is plunging into the access opening 32. In this way, the access opening 32 remains tightly sealed while the handling unit 14 is still outside the work zone 15.

The handling unit 14 breaks into the work zone 15 through the access slit 47, resulting in the access slit 47 coming open and the components of the diaphragm 46 flanking the access slit 47 being pushed together according to the arrows 49. Due to its elasticity, the parts of the diaphragm 46 that are spread apart nonetheless sit tight against the outer surface of the handling unit 14 pushing through the access opening 32, so that in this state also there is hardly any possibility of contamination from the handling zone 33 penetrating the work zone 15.

In the exemplary embodiment illustrated in FIG. 7 the barrier device 43 contains an axially elastically deformable bellows 48, positioned coaxially around the handling unit 14 and secured with an axial end all around the access opening 32 to the protective cover 25 and with its opposing axial end to a supporting section 52 of the handling device 13 supporting the handling unit 14. Thus, on the outside of the protective cover 25, a protected space 53 adjoins the access opening 32, surrounded by the bellows 48 and which is tightly sealed off from the adjacent handling zone 33, irrespective of the relative position adopted in the axial direction of the application movement 23 between the handling unit 14 and the protective cover 25. During the application movement 23 the bellows 48 are simply axially distended or shortened, without a connection between the access opening 32 and the handling zone 33 being released.

It goes without saying that the exemplary embodiments illustrated in FIGS. 5 to 7 are merely the particularly most advantageous, and that there are other possibilities for implementing the barrier device 43.

The positioning movement 7 of the pallets 3 can be brought about by means of a drive system 54 of the positioning system 2. The drive system 54 allows the abovementioned generation of the positioning movement 7 through overlaid x-driven movements 5 and y-driven movements 6. An electrically operated drive system 54, particularly, is involved.

In a variant of the drive system 54 (not shown) the driving force bringing about the positioning movement 7 is implemented by means of an electrodynamic linear direct drive system. This allows an advantageous, contactless power transmission associated with particularly low wear.

In the exemplary embodiment, the drive system 54 is implemented as a driving gear system 54′, configured according to the driving gear system described in EP 2982472 A1.

The driving gear system 54′ comprises a driven gear structure 55 on the outside of the protective cover 25 facing away from pallet 3, which by way of example is the outside of the bottom wall 36. This driven gear structure 55 is comprised of a plurality of driven teeth 56 intermittently distributed in plane parallel to the positioning plane 4, positioned in a two-dimensional tooth matrix on the intersections of x-gridlines 57 and y-gridlines 58, at right-angles to each other, of an imaginary cross grid.

The driving gear system 54′ further comprises a plurality of driving gears 59 rotatably supported on the system base 8, some configured as x-driving gears 59a and some as y-driving gears 59b. The x-driving gears 59a serve to generate the x-driven movement 5 and are rotatable about an axis parallel to the y-axis. The y-driving gears 59b provide for the generation of the y-driven movement 6 and are in each case rotatable about an axis parallel to the x-axis. The driving gears 59 are arranged distributed across the positioning plane 4 such that both in the x-axial direction and in the y-axial direction in each case an alternating sequence of rows of drive teeth results, with in each case one drive teeth row comprising x-driving gears 59a and the respective other drive teeth row y-driving gears 59b. This can also be referred to as a matrix-like arrangement. All driving gears 59 are provided on their outer circumference with drive teeth 60, extending as in normally the case with gears around the rotational axis of the respective driving gear 59.

The pallets 3 are positioned from the protective cover 25 side on the arrangement of driving gears 59, the distribution of which is selected so that each pallet 3 located within a work zone 15 is always in simultaneous engagement with at least one x-driving gear 59a and at least one y-driving gear 59b. Here the pallet 3 rests with its weight force on the driving gears 59 concerned. Depending on which of the driving gears 59 are driven in which direction of rotation and at what speed, the positioning movement 7 sought results, by which the pallets 3 with their driven gear structure 55 move away via the arrangement of driving gears 59 and one after another engage teeth with various of these driving gears 59.

The protective cover 25 is in this connection expediently also designed as a support device 61, by which the pallets 3 can be or are supported on their upper surface opposite their driven gear structure 55 in the direction of the application movement 23. The height of the pallets 3 measured at right-angles to the positioning plane 4, particularly of the pallet main body 34, is selected so that the pallets 3, when they engage with the driving gears 59, fit closely against the inner surface 62 of the protective cover 25 facing towards the positioning space 26 such that they can slide smoothly or only have a small distance from this inner surface 62. This effectively prevents the driven gear structures 55 during the positioning movement 7 of the pallets 3 jumping out of the drive teeth 60 of the driving gears 59, which could lead to inaccuracy of the positioning of the pallets 3.

What is claimed is:

1. A working device comprising a positioning system containing at least one pallet which is positionable and movable by performing a two-dimensional positioning movement in a positioning plane, the at least one pallet having at least one application area, on which, in a work zone of the positioning plane, an application can be performed by means of a handling unit of a handling device, wherein the work zone is separated from the handling unit by a protective cover having an access opening for the handling unit, and wherein the handling unit can be moved perpendicularly to the positioning plane by performing an application movement, each application area of the pallet being able to be positioned in the area of the access opening by the positioning movement in order to allow an application to be performed on the application area, which is positioned in the area of the access opening, through the access opening by means of the handling unit.

2. The working device according to claim 1, wherein the positioning plane is horizontally aligned and the upper side of the work zone is covered by the protective cover, wherein the handling unit is positioned above the work zone and the application movement is a vertical movement.

3. The working device according to claim 1, wherein the protective cover extends across the entire positioning plane.

4. The working device according to claim 1, wherein the positioning plane extends across a plurality of work zones, to each of which is associated an own handling unit physically separated by the protective cover, wherein the protective cover in the area of each work zone has an access opening for the associated handling unit.

5. The working device according to claim 4, wherein a plurality of work zones are arranged in the positioning plane at a distance from each other and are connected to each other by a transfer zone.

6. The working device according to claim 5, wherein the positioning system in the transfer zone is configured so that it can produce an exclusively one-dimensional, linear positioning movement of the at least one pallet.

7. The working device according to claim 1, wherein the positioning system is configured as an x-y-positioning system and the at least one pallet for performing the positioning movement is driven by a drive system relative to a stationary system base both alternately and overlaid to an x-drive movement directed in an x-axial direction and to a y-drive movement in a y-axial direction at right-angles to the x-axial direction.

8. The working device according to claim 7, wherein to generate the x-drive movement and the y-drive movement the drive system is configured as a driving gear system.

9. The working device according to claim 1, wherein at least one pallet has a pallet main body and in this regard separately one or more pallet application bodies each defining an application area.

10. The working device according to claim 1, wherein the at least one pallet has a plurality of application areas arranged parallel to the positioning plane with a matrix-like distribution.

11. The working device according to claim 1, wherein at least one application area of at least one pallet is predefined as a receptacle that by means of the handling unit can be filled and/or at least to some extent emptied through the access opening.

12. The working device according to claim 1, wherein the at least one pallet has a tray-like pallet main body, the open side of which faces towards the protective cover.

13. The working device according to claim 1, wherein the protective cover has a plate-like configuration.

14. The working device according to claim 13, wherein the protective cover is detachably and removably arranged on a system base of the positioning system.

15. The working device according to claim 1, wherein the protective cover is transparent and/or is made of glass.

16. The working device according to claim 1, wherein the work zone is located in a positioning space of the positioning system sealed off from the environment.

17. The working device according to claim 16, wherein the positioning space is designed to be climate controlled or to be applicable by excess pressure.

18. The working device according to claim 1, wherein the access opening is associated with a barrier device, which at least temporarily impedes or completely prevents entry of contamination into the work zone from the handling unit side.

19. The working device according to claim 18, wherein the barrier device is formed by a collar-like elevation of the protective cover surrounding the access opening or by at least one rubber-elastic diaphragm spanning the access opening or by a deformable bellows extending between on the one hand the protective cover and on the other hand a supporting section of the handling device supporting the handling unit.

20. The working device according to claim 1, wherein the protective cover also forms a support device supporting the at least one pallet at right-angles to the positioning plane.

21. A working device comprising a positioning system containing at least one pallet which is positionable and movable by performing a two-dimensional positioning movement in a positioning plane, the at least one pallet having at least one application area, on which, in a work zone of the positioning plane, an application can be performed by means of a handling unit of a handling device, wherein the work zone is separated from the handling unit by a protective cover having an access opening for the handling unit and wherein the handling unit can be moved perpendicularly to the positioning plane by performing an application movement, each application area of the pallet being able to be positioned in the area of the access opening by the positioning movement in order to allow an application to be performed on the application area, which is positioned in the area of the access opening, through the access opening by means of the handling unit, wherein the positioning system is configured as an x-y-positioning system having an electrically operated driving gear system for driving the at least one pallet to perform its positioning movement as alternate or overlaid movements in an x-axial direction and/or in an y-axial direction at right-angles to the x-axial direction, wherein the driving gear system has a plurality of driving gears rotatably supported on a stationary system base of the positioning system and a driven gear structure on each pallet which is in driven engagement with any the driving gears, wherein the protective cover forms a support device supporting the at least one pallet at right-angles to the positioning plane for preventing jumping of the driven gear structure of the at least one pallet out of engagement of the driving gears.
